(19) United States
(12) Patent Application Publication
(10) Pub. No.: US 2010/0032275 A1
(43) Pub. Date: Feb. 11, 2010

(54) DEVICE FOR GALVANIC ISOLATION OF A SEMICONDUCTOR SWITCH, ELECTRONIC SWITCHING DEVICE AND CONTACT-MAKING AND ISOLATING MODULE

(76) Inventor: Markus Meier, Rieden (DE)

Correspondence Address: HARNESS, DICKEY & PIERCE, P.L.C., P.O.BOX 8910, RESTON, VA, 20195, US

(21) Appl. No.: 12/448,165

(22) PCT Filed: Dec. 14, 2006
(86) PCT No.: PCT/DE2006/002252

§ 371 Date: Jun. 11, 2009

(51) Int. Cl. H01H 9/00

(52) U.S. Cl. 200/502

(57) ABSTRACT

In at least one embodiment of a device for galvanic isolation of an electrical connection from a semiconductor switch, the semiconductor switch has two switching contacts and a control contact. The device has a printed circuit board on which at least the semiconductor switch and the electrical connection are arranged. The first switching contact of the semiconductor switch is connected to the printed circuit board, and the second switching contact is connected to the electrical connection. According to at least one embodiment of the invention, the device has a controllable actuator whose length can be varied and which has two actuator contacts, which are separated by the length of the actuator and are conductively connected to one another. The first actuator contact rests on the second switching contact. The second actuator contact makes contact, depending on the operation of the actuator, with the electrical connection, or is galvanically isolated from it, forming an isolation gap. At least one embodiment of the invention also relates to an electronic switching device, and to a contact-making and isolation module.

### PRIORITY STATEMENT

This application is the national phase under 35 U.S.C. §371 of PCT International Application No. PCT/DE2006/002252 which has an International filing date of Dec. 14, 2006, which designated the United States of America, the entire contents of which is hereby incorporated herein by reference.

### FIELD

At least one embodiment of the invention generally relates to a device for electrically isolating a first electrical terminal from a semiconductor switch embodied in plate- or disk-shaped fashion. In at least one embodiment, the semiconductor switch has a first switching contact on an underside of the semiconductor switch, a second switching contact on a top side of the semiconductor switch and a control contact. The first switching contact of the semiconductor switch is connected to a second electrical terminal. The second switching contact can be electrically isolated from the first electrical terminal by way of a drivable actuator with the formation of an isolating distance.

At least one embodiment of the invention furthermore generally relates to an electronic switching device, in particular a power module, comprising a device of this type.

Finally, at least one embodiment of the invention generally relates to a contact-making and isolating module for mounting on a printed circuit board and for making contact with a semiconductor switch on the printed circuit board.

### BACKGROUND

The U.S. Pat. No. 4,943,890A discloses an electronic motor starter arrangement wherein drivable semiconductor components are electrically conductively arranged between heat sink elements. The electrical power can be connected to or isolated from one of the heat sink elements by way of an electrical contact by the actuation of a movable contact which can be driven by way of an electrical coil and which interacts with a fixed contact on the relevant heat sink element.

Devices for electrically isolating an electrical terminal from a semiconductor switch are generally known. The best-known devices are contactors or switching relays, for example, which, upon corresponding driving, establish an isolating distance that effects electrical isolation, such as an air gap, for example, between a voltage-carrying electrical terminal and the relevant semiconductor switch.

The devices mentioned above can be necessary since electronic switching devices, such as soft starters, for example, even with the switching device switched off, can transfer a voltage of up to hundreds of volts that takes effect from the voltage-carrying electrical terminal to the output-side electrical terminal. Even if only a small current flows when the output-side terminal is touched, this current can already be fatal to a person upon contact.

A further problem exists if a semiconductor switch, such as e.g. a switching transistor, a thyristor or triac, breaks down, such as e.g. on account of a thermal overload. In such a case, the entire input-side voltage is present, such as e.g. a DC voltage of hundreds of volts up to a few thousand volts.

In specific applications, in particular safety-critical or safety-relevant applications, such as e.g. in the case of elevator starters, relevant standards may stipulate that an additional electromechanical switching element, such as e.g. an isolating contactor, be connected upstream or downstream of the electronic switching device.

The known electronic switching devices can have a switching power in a range of 5 kW to 500 kW. Switching devices of this type are also referred to as power modules. They can have one, two or more semiconductor switches. In particular, the semiconductor switches are IGBT transistors, thyristors or triacs, wherein a triac, for its part, comprises two thyristors connected back-to-back. A triac is preferably embodied as an individual component in the lower power range, such as e.g. up to 10 kW. In the upper power range, such as e.g. in the range of 5 kW up to 500 kW, it is preferably realized from two individual thyristors connected back-to-back.

The semiconductor switches of such power modules are preferably arranged on a printed circuit board. The printed circuit board is typically a so-called DCB (stands for direct copper bonding). A DCB is a sandwich comprising two copper layers and a ceramic layer lying inbetween. In comparison with conventional printed circuit boards, such as e.g. epoxy printed circuit boards, such a DCB permits considerably higher temperatures for the components to be carried, in particular of the power semiconductors.

In this power range, the individual semiconductor switches are typically embodied in plate- or disk-shaped fashion. They preferably have two switching contacts and a control contact, wherein one of the switching contacts and the control contact are situated on the top side of the semiconductor switch and the other switching contact is situated on the underside of the semiconductor switch. The switching contacts are an emitter and collector in the case of an IGBT, and a cathode and an anode in the case of a thyristor. The control contact is also referred to as a gate.

The underside of the semiconductor switch is preferably soldered with a corresponding contact-making area on the printed circuit board. The switching and control contacts lying on the top side are wired by way of so-called bonding wires, such as e.g. composed of aluminum, directly to corresponding contact-making areas on the printed circuit board. This contact-making form is possible particularly in the case of currents to be switched in a range of approximately 50 A to 200 A. However, this type of contact-making has the disadvantage that the bonding wires can vaporize in a short-circuit situation, which then leads to a failure of the switching device.

At higher currents, such as e.g. in a current range of 100 A to 500 A, press-on systems are employed, which make contact with the top side of the semiconductor switch. These systems are usually screwed to the printed circuit board. An advantage of this so-called pressure contact-making is the better short-circuit behavior in comparison with the bonding contact-making solution and heat dissipation from the semiconductors.

### SUMMARY

At least one embodiment of the invention specifies a device that is less complicated and at the same time more compact.

Furthermore, at least one embodiment of the invention specifies a switching device comprising a device of this type.

At least one embodiment of the invention specifies a suitable contact-making and isolating module for mounting on a printed circuit board.

A feature of an embodiment of the invention is an electrical isolation of the semiconductor switch from the respective electrical terminal, which electrical isolation can be chosen directly at the semiconductor switch by way of an actuator.

According to at least one embodiment of the invention, the device has a circuit carrier, on which at least the semiconductor switch and the second electrical terminal are arranged. The first switching contact of the semiconductor switch is connected by the underside thereof to the circuit carrier and further via the latter to the second electrical terminal. The actuator can be varied in terms of its length and has two actuator contacts, which are spaced apart by the length of the actuator and are conductively interconnected. In this case, the first actuator contact bears on the top side of the second switching contact. Depending on the driving of the actuator, the second actuator contact makes contact with the first electrical terminal or it is electrically isolated from the latter with the formation of the isolating distance.

As a result, in comparison with the prior art, an electrical isolation of the semiconductor switch from the associated electrical first terminal is possible. An otherwise possible transfer of the input voltage present at the first electrical terminal via the depletion layer of the semiconductor switch to the electrical output-side second terminal is advantageously no longer possible. Danger to persons should they touch such an output-side terminal is precluded.

A further advantage is that, in the case of a breakdown of a semiconductor switch, the entire input voltage is not present at the output-side second electrical terminal. In addition, as a result of the electrical isolation, it is advantageously possible for the electrical load to be turned off. As a result, e.g. an electric motor can still be turned off before the machine or installation components driven by the electric motor can incur damage.

The electrically isolating distance which can be established by the actuator is typically in the millimeters range, such as e.g. 1 mm to 3 mm. The isolating distance can also be larger at higher voltages, in particular in the kilovolts range. The isolating distance is typically an air clearance. The isolating distance can alternatively be established in a gas other than air, such as e.g. in nitrogen or in sulfur hexafluoride (SF₆). Sulfur hexafluoride is a gas that is often used for high-voltage insulation in the field of electrical engineering. In this case, the isolating distance can be drastically reduced in comparison with air, since the breakdown strength capacity of sulfur hexafluoride is approximately three times higher than that of air or nitrogen.

The actuator can preferably be driven electrically. It can alternatively be driven pneumatically or hydraulically. In particular, upon corresponding driving, the actuator effects a linear length variation. The possible length variation is also referred to as actuating travel.

The actuator can be based e.g. on a piezoelectric principle of action. In this case, it is referred to as a piezo-actuator, which can vary its length depending on the applied voltage. Piezo-actuators are used e.g. in injection systems of diesel engines.

As an alternative, the actuator can be based on a magnetostrictive principle of action. Magnetostriction denotes the reversible deformation of ferromagnetic substances, such as e.g. terfenol, depending on an applied magnetic field. In this case, the body experiences an elastic length change given a constant volume.

The actuating movement of the actuator can furthermore be based on a shape memory principle. Actuators of this type are also referred to as memory metal actuators.

An actuator can furthermore alternatively be a solenoid or plunger-type magnet with a plunger-type coil that is electrically excited in the event of driving.

In one embodiment, the second switching contact and the control contact are arranged on the top side of the semiconductor switch. The first switching contact is arranged on the underside of the semiconductor switch, the underside being parallel to the top side. A semiconductor switch of this type is, in particular, a semiconductor switch without a housing. Such a semiconductor switch is essentially composed of the semiconductor chip itself, the so-called “die”. Contact-making areas, in particular for bonding or for contact-connection, can additionally be present on the die. The compact design permits a low-impedance connection of the semiconductor switch to the printed circuit board in conjunction with a low heat transfer resistance for the cooling of the semiconductor switch.

According to a further embodiment, the printed circuit board has a printed circuit board contact area on which the first switching contact of the semiconductor switch bears. This results in a further reduction of the electrical and thermal resistance from the underside of the semiconductor switch to the printed circuit board.

In particular, the first switching contact is electrically connected to the printed circuit board contact area via a soldering connection.

According to a particular embodiment, the actuator has a cross section substantially co-ordinated with the cross section of the semiconductor switch. An even more compact design is possible as a result. A very low ohmic resistance from the actuator to the semiconductor switch is possible at the same time. The semiconductor switch can have, for example, a circular cross section having a diameter of a few centimeters. In this case, the actuator is embodied in cylindrical fashion and has a likewise circular cross-sectional area.

As an alternative, the semiconductor switch and the actuator can have a square, rectangular or polygonal cross-sectional form.

According to a particular embodiment, the actuator has a through opening through which contact can be made with the control contact of the semiconductor switch. The through opening is preferably a cylindrical hole or cutout in the actuator. In particular, the through opening in the actuator is arranged centrally and parallel to the direction of extent of the actuator.

Advantageously, in the case of a cylindrical actuator, the axis of rotational symmetry of the actuator coincides with the longitudinal axis of the hole or cutout. The lead-through opening is embodied such that it is insulated with respect to the outer switching contact. Through the lead-through opening, a contact-making element, in particular a cylindrical metal spring, can make contact with a contact-making area of the gate, said area typically likewise being arranged in the center on the top side of the semiconductor switch. Consequently, the gate of the semiconductor switch is routed to an outer side of the actuator through the through opening.

In accordance with a further embodiment, the first electrical terminal has a terminal contact lying opposite the second actuator contact. Consequently, the terminal contact lies directly in the actuating travel of the actuator. As a result, with the actuator extended, a reliable contact-connection of semiconductor switch to the electrical terminal can possibly be set and, with the actuator “contracted”, a sufficiently large isolating distance between actuator and semiconductor switch can possibly be set.

As described in the introduction, the two actuator contacts are electrically interconnected. In particular, the electrical resistance of the first and second actuator contacts is also dimensioned to be so low that no appreciable heating of the actuator takes place during rated operation. Preferably, the entire outer surface of the actuator, apart from the necessary insulation with respect to the through opening, is embodied in electrically conductive fashion. By way of example, the outer surface of the actuator that lies between the actuator contacts can be embodied in the sense of bellows. As an alternative, it is also possible for the actuator contacts to be electrically connected by way of a moveable conductor such as e.g. a multiple-stranded wire composed of a copper braiding.

According to one example embodiment, the abovementioned contacts are embodied in flat fashion, in particular in plane fashion. A possibly excessively high current density is avoided as a result.

According to one advantageous embodiment, the device has a control unit, which drives the actuator for setting the actuator length. The control unit can be a microcontroller, for example, which, alongside the driving functionality for the switching contact or switching contacts, additionally has the driving functionality for the actuator or actuators.

At least one embodiment of the invention is furthermore directed to an electronic switching device having such a device according at least one embodiment of to the invention. In particular, such a switching device has the first and second electrical terminal.

Furthermore, the switching device has a control terminal, which is connected to the control unit for switching on or off the semiconductor switch and the actuator. It furthermore has a housing, on the outer side of which the electrical terminals and the control terminal are arranged and which has the device and the control unit. The housing can be for example a nonconductive plastic or a ceramic.

In comparison with switching devices according to the prior art, the electronic switching device according to at least one embodiment of the invention advantageously has an additionally integrated electrical isolation. An additional external switching device, such as an isolating contactor, for example, is not necessary. Such switching devices according to at least one embodiment of the invention can therefore also be used for safety-critical or safety-relevant applications.

The switching device can furthermore have two or more devices according to at least one embodiment of the invention, that is to say that it can be embodied in polyphase fashion.

In particular, the actuator and the semiconductor switch can be driven in a manner dependent on a switch-on or switch-off command by way of the control unit. As a result, an additional drive signal for the actuator is not necessary. In particular, the actuator is driven for closing the isolating distance by way of the switch-on command. Preferably, the semiconductor switch is driven only when the actuator has made contact with the voltage-carrying electrical terminal. By contrast, in the case of a switch-off command, the driving of the actuator for establishing the isolating distance is preferably effected only when the semiconductor switch has changed to off-state operation.

The switching device described above is preferably a DC switching device for switching DC currents or DC voltages. The semiconductor switch can be for example an IGBT transistor or a MOSFET transistor.

As an alternative, the switching device can be an AC switching device for switching AC currents or AC voltages. In this case, the semiconductor switch is preferably a triac.

According to a further embodiment, the device has two thyristors connected back-to-back as semiconductor switches, the first and second electrical terminal and also a first and second actuator. The first switching contact of the first thyristor is connected to the second electrical terminal via the printed circuit board. Separately therefrom the first switching contact of the second thyristor is connected to the first electrical terminal via the printed circuit board. The first actuator contact of the first actuator bears on the second switching contact of the first thyristor and the first actuator contact of the second actuator bears on the second switching contact of the second thyristor. Depending on the driving of the actuators, the second actuator contact of the first actuator either makes contact with the first electrical terminal and the second actuator contact of the second actuator makes contact with the second electrical terminal, or the two actuator contacts are electrically isolated from the respective electrical terminal with the formation of an isolating distance.

This embodiment of the invention is advantageous for the upper power range, that is to say for electrical powers to be switched in a range of 5 kW to 500 kW. From a circuitry standpoint, the two thyristors that are embodied separately and connected up to one another back-to-back form a triac for switching AC currents. The switching process typically takes place at the zero crossing of the current profile. The current intensity of the current to be switched can amount to hundreds of amperes in this case.

For the complete electrical isolation of the input-side electrical terminal from the output-side electrical terminal, simultaneous driving of the actuators is necessary, such that an isolating distance is established with regard to each electrical terminal.

At least one embodiment of the invention is furthermore achieved by way of a further electronic switching device, having a control terminal, which is connected to the control unit for switching on or off the thyristors and the actuators. This further electronic switching device according to at least one embodiment of the invention has a housing, on the outer side of which the electrical terminals and the control terminal are arranged and which has the device according to at least one embodiment of the invention and the control unit.

In comparison with switching devices according to the prior art, the further electronic switching device according to at least one embodiment of the invention advantageously has an additional integrated electrical isolation. An additional switching device, such as an isolating contactor, for example, is not necessary.

The further switching device can have two or more devices according to at least one embodiment of the invention, that is to say that it can be embodied in polyphase fashion. The switching device can be embodied in particular in 3-phase fashion for switching currents and voltages of a 3-phase power supply system. A three-phase power supply system can be e.g. a 400V/50 Hz three-phase power supply system of a power supply utility.

Switching devices of this type can therefore also be used for safety-critical or safety-relevant applications, such as e.g. for driving elevator motors.

At least one embodiment of the invention furthermore is directed to a contact-making and isolating module for mounting on a printed circuit board. The contact-making and isolating module has a module housing, an actuator, an electrical terminal, a control terminal and a control contact terminal. The actuator is accommodated in the module housing and can be driven such that it can be set in terms of its length. The actuator additionally has two actuator contacts, which are spaced apart by the length of the actuator and are conductively interconnected, wherein the first actuator contact is embodied for making contact with a second switching contact—arranged on the printed circuit board—on the top side of a semiconductor switch. The second actuator contact lies opposite a terminal contact arranged on an inner side of the module housing. The terminal contact is connected to the electrical terminal arranged on the outer side of the module housing. The actuator has a through opening embodied in such a way that a control contact arranged on the top side of the semiconductor element can be contact-connected to the control contact terminal through the through opening. Depending on the driving of the actuator, the second actuator contact makes contact with the terminal contact or is electrically isolated from the latter with the formation of an isolating distance.

A module of this type can be contact-connected in an advantageous simple manner to a semiconductor switch fitted, in particular soldered, on the printed circuit board, wherein a drivable electrical isolation from the electrical terminal of the module with respect to the contact-connected semiconductor switch is possible at the same time. The module can be screwed onto the printed circuit board, for example. It can alternatively have fixing bolts that are geometrically co-ordinated with cutouts in the printed circuit board. The fixing bolts can have latching hooks or barbs in the end region, such that the module can be latched or snapped into the printed circuit board.

A further advantage is that the semiconductor switch is pressed against the printed circuit board contact area by the mounting of the contact-making and isolating module.

### BRIEF DESCRIPTION OF THE DRAWINGS

The invention and advantageous embodiments of the invention are described in more detail below with reference to the following figures, in which:

FIG. 1 shows by way of example a circuit diagram of a load connected to an electrical power supply system via a switching device according to the prior art,

FIG. 2 shows an example of a contact-connection of semiconductor switches by way of bonding wires according to the prior art,

FIG. 3 shows a basic circuit diagram of the device according to an embodiment of the invention,

FIG. 4 shows by way of example a structural embodiment of the device according to an embodiment of the invention with a semiconductor switch,

FIG. 5 shows an example contact-making and isolating module according to an embodiment of the invention,

FIG. 6 shows a circuit diagram of a load connected to an electrical power supply system via a switching device according to an embodiment of the invention,

FIG. 7 shows by way of example a circuit diagram of an AC current switch comprising two thyristors connected up back-to-back with the selectable electrical isolation according to an embodiment of the invention,

FIG. 8 shows an example structural embodiment of the device according to an embodiment of the invention with two thyristors connected up back-to-back.

FIG. 9 shows a first timing diagram, and

FIG. 10 shows a second timing diagram.

### DETAILED DESCRIPTION OF THE EXAMPLE EMBODIMENTS

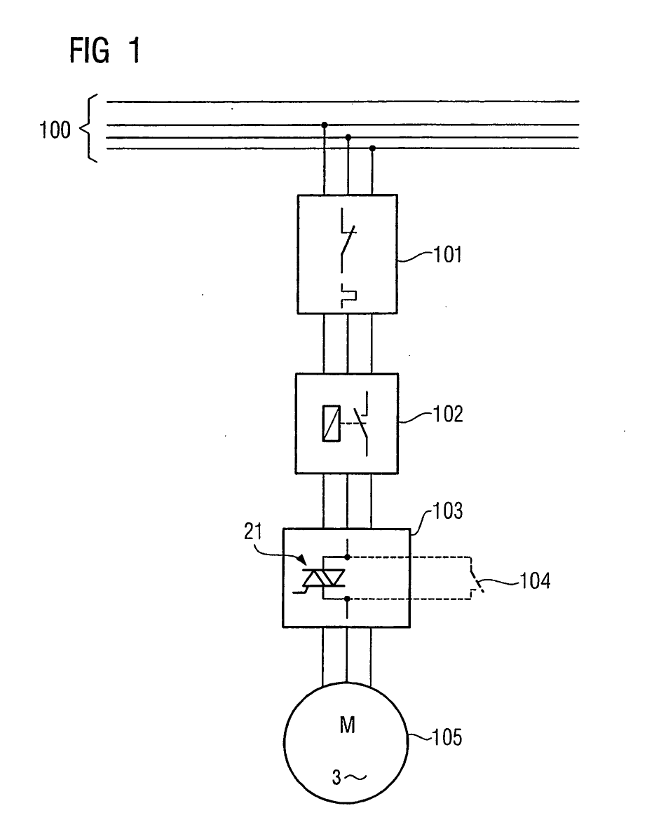

FIG. 1 shows by way of example a circuit diagram of a load 105 connected to an electrical power supply system 100 via a switching device 103 according to the prior art.

The switching device 103 is a soft starter embodied in 3-phase fashion, for example. It enables a “soft” connection and a soft disconnection of the load 105. The load 105 is a three-phase motor, by way of example. The electrical power supply system 100 is a 3-phase power supply system. The switching device 103 has for example a triac as semiconductor switch 21. The triac comprises two thyristors connected back-to-back. Via a gate (not designated any further), the load 105 can be switched on or off in ramped fashion in the sense of phase gating control. An optional bypass switch is designated by the reference symbol 104. It bypasses the triac 21 after the end of the start-up ramp has been reached. Electrical losses in the form of heat that would arise at the triac 21 during rated operation are thereby avoided.

The reference symbol 101 designates a protective device that isolates the electronic switching device 103 from the power supply system 100 in the case of an over current and/or a short circuit.

The reference symbol 102 designates an isolating contactor, which can turn off the power supply system voltage particularly in the case of safety-relevant applications in order to avoid a transfer of the power supply system voltage toward the output of the electronic switching device 103. It can likewise be driven by the presence of a switch-off command for the switching device 103 for switching-off.

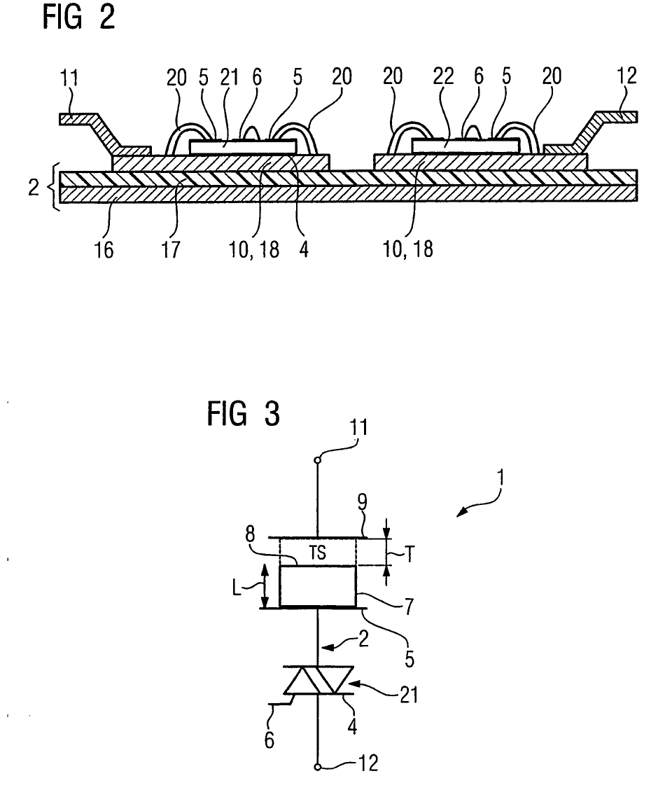

FIG. 2 shows an example of a contact-connection of semiconductor switches 21 and 22 by way of bonding wires 20 according to the prior art.

The lower part of FIG. 2 illustrates a printed circuit board 2 having an insulating ceramic layer 17 and two copper layers 16, 18 surrounding the latter. The copper layer 18 forms corresponding printed circuit board contact areas to which the two semiconductor switches 21, 22 are contact-connected, in particular soldered. The reference symbol 4 designates a first switching contact of the semiconductor switch, 5 designates a second switching contact, and 6 a control contact, such as e.g. a gate. The two contacts 5, 6 mentioned last are electrically connected to further contact-making areas (not designated any further) by way of bonding wires 20. Electrical terminals 11, 12 as input and output of the circuits shown are illustrated in the left-hand and right-hand parts of FIG. 2.

FIG. 3 shows a basic circuit diagram of the device 1 according to an embodiment of the invention.

An input-side electrical terminal is designated by the reference symbol 11. It is typically connected to the power supply system 100. An output-side electrical terminal is designated by the reference symbol 12. It is typically connected to the load 105. The lower part of FIG. 3 illustrates a triac 21 for switching AC voltages or AC currents.

For electrically isolating the electrical terminal 11 from the semiconductor switch 21, the device 1 shown has a printed circuit board 2, which is not illustrated any further and is only indicated in circuitry terms and on which at least the semiconductor switch 21 and the electrical terminal 11 are arranged. The first switching contact 4 is connected to the printed circuit board 2, and the second switching contact 5 is connected to the electrical terminal 11. The control contact is designated by the reference symbol 6.

According to an embodiment of the invention, the device 1 has a drivable actuator 71, which can be altered in terms of its length L and which has two actuator contacts 7, 8, which are spaced apart by the length L of the actuator 71 and are conductively interconnected. The first actuator contact 7 bears on the second switching contact 5. Depending on the driving of the actuator 71, the second actuator contact 8 either makes contact with the electrical terminal 11 (dashed illustration) or it is electrically isolated from the latter with the formation of an isolating distance TS. The reference symbol 9 designates a terminal contact of the electrical terminal 11, said terminal contact lying opposite the actuator contact 8.

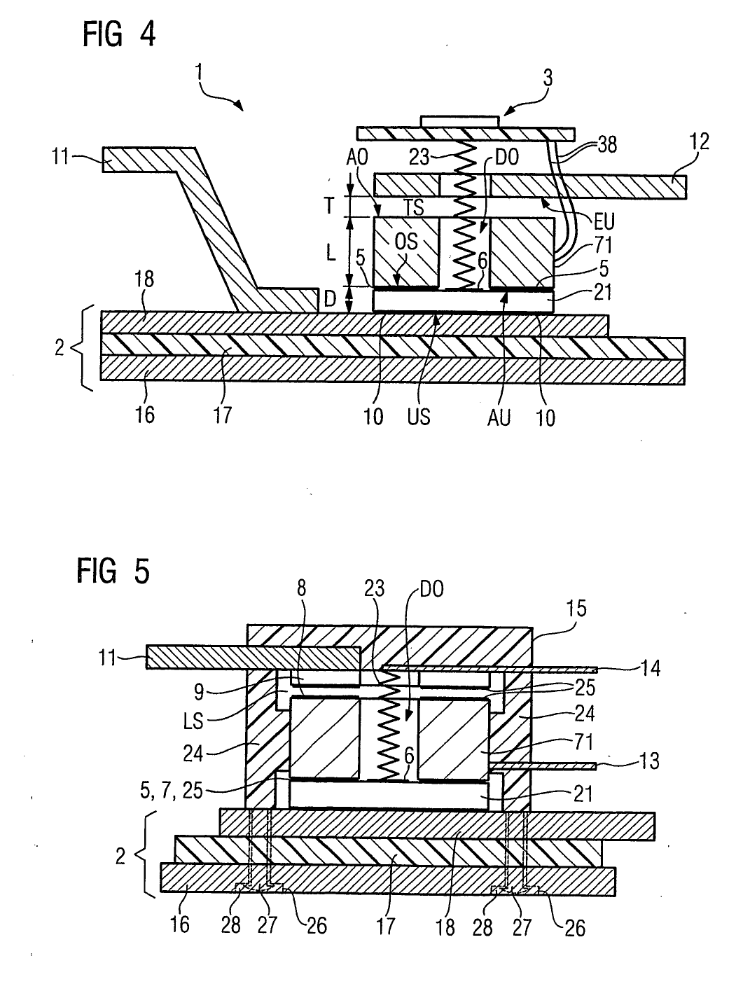

FIG. 4 shows by way of example a structural embodiment of the device 1 according to an embodiment of the invention with a semiconductor switch 21 as an individual component.

In the example in FIG. 4, the semiconductor switch 21 is a triac having two thyristors which are integrated on a semiconductor chip and are connected back-to-back. The semiconductor switch 21 is embodied in plate-shaped or disk-shaped fashion. It has a thickness D. Furthermore, the second switching contact 5 and the control contact 6 are arranged on a top side OS of the semiconductor switch 21. The first switching contact 4 is arranged on an underside US of the semiconductor switch 3, said underside being parallel to the top side OS.

The printed circuit board 2 substantially corresponds to the one shown in FIG. 2. The printed circuit board 2 has a printed circuit board contact area 10 which is embodied in plane fashion and on which the first switching contact 4 of the semiconductor switch 21 bears. In particular, the first switching contact 4 is electrically connected via a soldering connection to the printed circuit board contact area 10, such that a low-impedance electrical junction with at the same time a low heat conduction resistance is possible. The soldering additionally ensures that the semiconductor switch 21 is fixed mechanically on the printed circuit board contact area 10.

The actuator 71 has a cross section substantially co-ordinated with the cross section of the semiconductor switch 21. The cross section of the semiconductor switch 21 and of the actuator 71 is circular in the example in FIG. 4. The actuator 71 can be e.g. a piezo-actuator, a magnetostrictive actuator or an actuator on the basis of a shape memory alloy. In particular, the actuator 71 can be driven electrically.

As shown by FIG. 4, the actuator 71, proceeding from the depicted length L of the actuator 71, in the event of driving, can expand by the length T of the isolating distance TS and thus eliminate the isolating distance TS or the air gap. Driving also means that the actuator 71 can contract or expand after cessation of the electrical excitation. The actuator 71 can furthermore have a mechanical prestressing spring for setting a desired switching position without excitation.

In the example in FIG. 4, the actuator 71 has a through opening DO, through which contact can be made with the control contact 6 of the semiconductor switch 21. For contact-making, a metallic cylindrical spring 23 is present, which is electrically connected to the gate 6 by one end and to a control unit 3 by the other end. In particular, the gate 6 is contact-connected in a releasable manner. The control unit 3 serves for setting the actuator length L and is therefore connected to the actuator 71 via driving lines 38. It can simultaneously serve for driving the semiconductor switch 21 and drive the actuator 71 and the semiconductor switch 21 in a manner dependent on a switch-on or switch-off command present. In the example in FIG. 4, the first electrical terminal 11 likewise has a through opening, through which the contact-making device 23 is led.

Furthermore, the contacts 4-8 illustrated, that is to say the switching contacts 4, 5, the control contact 6 and the actuator contacts 7, 8, are embodied in flat or plane fashion. In this case, AO designates the outer side of the actuator, and EU designates that contact area of the first electrical terminal 11 which lies opposite the outer side AO of the actuator 71. The contacts 4-8 can have a particularly conductive coating suitable for frequent switching actions and/or for a good durable contact-connection, such as e.g. a coating composed of a cobalt, copper or silver alloy.

The device 1 shown can be part of an electronic switching device (not illustrated any further). A switching device of this type has, besides the preferably input-side first electrical terminal 11, a second, in particular output-side, electrical terminal 12. The latter is connected to the first switching contact 4 of the semiconductor switch 21 via the printed circuit board 2. The switching device furthermore has a control terminal 13, which is connected to the control unit 3 for switching on or off the semiconductor switch 21 and the actuator 71. It additionally has a housing, on the outer side of which the electrical terminals 11, 12 and the control terminal 13 are arranged. The housing itself accommodates the device 1 and the control unit 3. The housing can be composed of a nonconductive plastic or of a ceramic.

FIG. 5 shows an exemplary contact-making and isolating module according to an embodiment of the invention.

The contact-making and isolating module serves for mounting on a printed circuit board 2 and for making contact with a semiconductor switch 21 arranged on the printed circuit board 2. It has a module housing 15, an actuator 71, an electrical terminal 11, a control terminal 13 and a control contact terminal 14. The actuator 71 is accommodated in the module housing 15 and can be driven such that it can be set in terms of its length L. It has two actuator contacts 7, 8, which are spaced apart by the length L of the actuator 71 and are conductively interconnected. The first actuator contact 7 is embodied for making contact with the second switching contact 5 arranged on the printed circuit board 2. The second actuator contact 8 lies opposite a terminal contact 9 arranged on an inner side of the module housing 15. The terminal contact 9 is connected to the electrical terminal 11 arranged on the outer side of the module housing 15. The actuator 71 has a through opening DO embodied in such a way that a control contact 6 arranged on the top side OS of the semiconductor element 21 can be contact-connected to the control contact terminal 14 through the through opening DO. Depending on the driving of the actuator 71, the second actuator contact 8 makes contact with the terminal contact 9 or it is electrically isolated from the latter with the formation of an isolating distance TS. The reference symbol 25 designates particularly conductive and switching-durable contact-making layers.

The module housing 15 is preferably produced from a nonconductive plastic or from a ceramic. The module housing 15 can be embodied in ribbed fashion in the sense of a heat sink. Improved cooling of the semiconductor switch 71 is possible as a result. The module housing 15 can be embodied in pot-shaped fashion. It can have air openings (not illustrated any further) in the outer region for the cooling of the semiconductor switch 21. Furthermore, the module housing 15 can have guides 24 which are formed on the inner side and which receive the actuator 71 in the module housing 15 and at the same time enable expansion of the actuator 71.

As is furthermore shown by FIG. 5, the actuator 71 has a cross section substantially co-ordinated with the cross section of the semiconductor switch 21 with which contact is to be made. The internal cross section of the module housing 15 is designed correspondingly in relation to the cross section of the actuator 71.

The lower part of FIG. 5 illustrates how the module housing 15 is mounted onto the printed circuit board 2. The module housing 15 of the contact-making and isolating module has bolts or pins 27, which can be led through corresponding holes or cutouts 26 in the printed circuit board 2 during mounting. The bolts 27 have latching hooks 28, for example, which latch the module housing 15 to the printed circuit board 2 after said module housing has been placed onto the printed circuit board 2 over the semiconductor switch 21. As an alternative, the module housing 15 can be screwed to the printed circuit board 2.

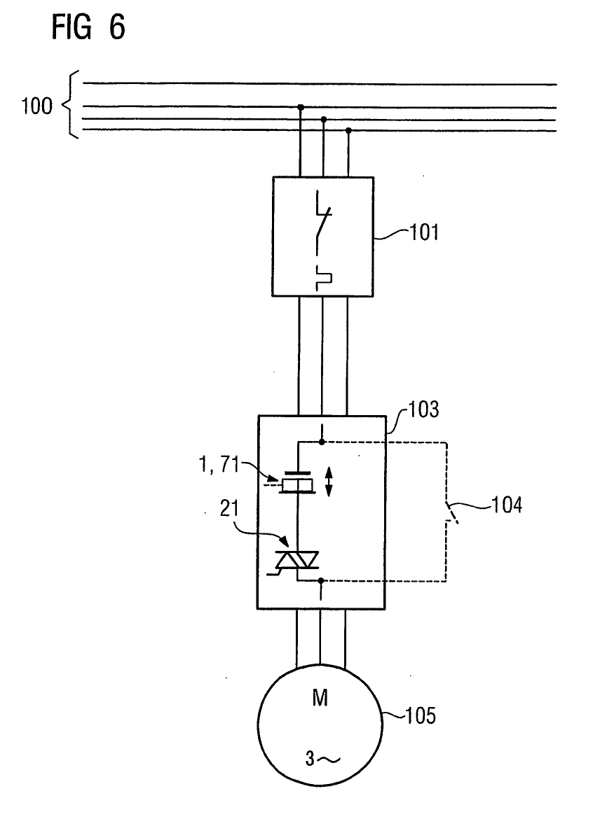

FIG. 6 shows a circuit diagram of a load connected to an electrical power supply system 100 via a switching device according to an embodiment of the invention.

In contrast to the circuit diagram in accordance with FIG. 1, the switching device 102 can be dispensed with. The electrical isolation is already integrated in the switching device 103 according to an embodiment of the invention.

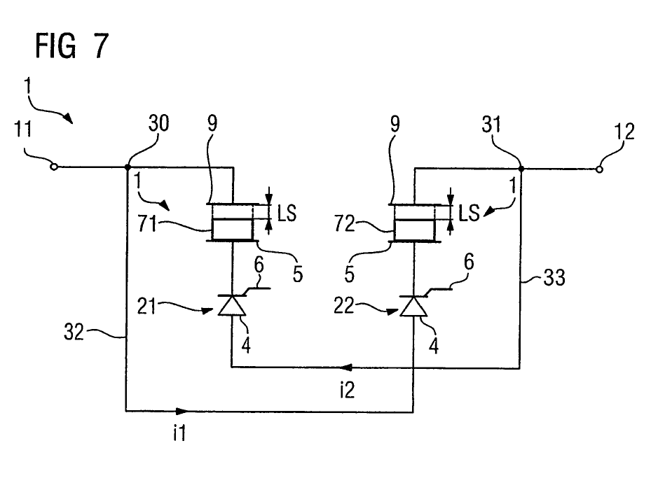

FIG. 7 shows by way of example a circuit diagram of an AC current switch comprising two thyristors 21, 22 connected up back-to-back with the possible electrical isolation according to an embodiment of the invention.

The input-side first terminal 11 is illustrated in the left-hand part of FIG. 7, and the output-side second terminal 12 in the right-hand part. i1 designates the current that flows in the first half-cycle of the AC current to be switched. i2 designates the current that flows in the second half-cycle of the AC current to be switched. As shown by FIG. 7, on account of the rectifying behavior of the thyristors 21, 22, the current i1 can flow only from the first terminal 11, via the connecting node 30, the current branch 32 into the first switching contact 4 of the right-hand thyristor 22 to the second terminal 12 if the thyristor 22 is switched on and the actuator 72 is not driven in isolating fashion. Correspondingly, the current i2 can only flow from the second terminal 12, via the connecting node 31, the current branch 33 into the first switching contact 4 of the left-hand thyristor 21 to the first terminal 11 if the thyristor 21 is switched on and the actuator 71 is not driven in isolating fashion. In the case of this circuit arrangement it can be discerned that two actuators 71, 72 are required for electrically isolating the terminals 11, 12 from the two thyristors 21, 22.

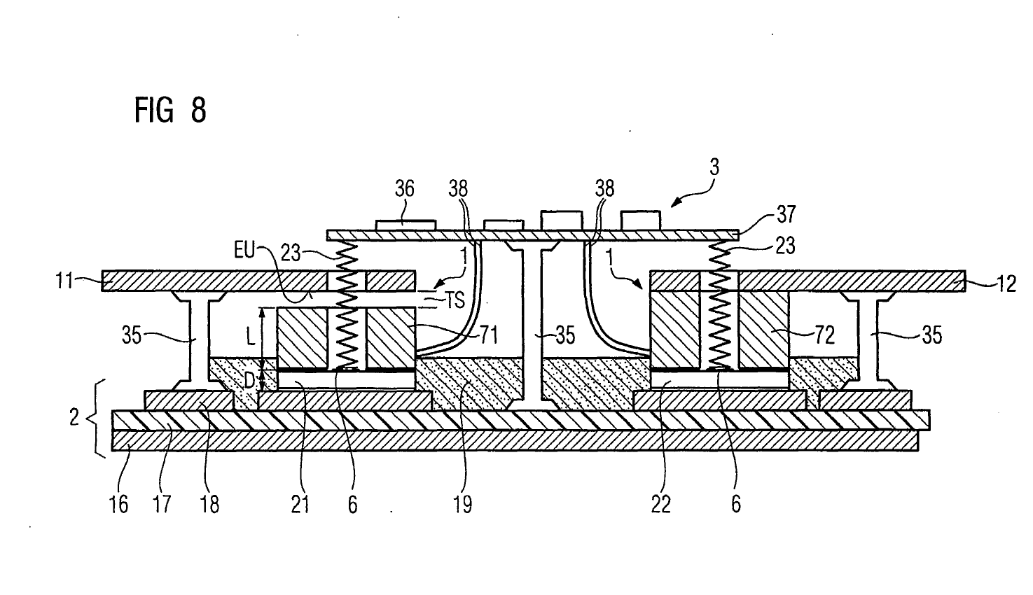

FIG. 8 shows an example structural embodiment of the device 1 according to an embodiment of the invention with two thyristors 21, 22 connected up back-to-back.

The device 1 has a first and second electrical terminal 11, 12 and a first and second actuator 71, 72. The first switching contact 4 of the first thyristor 21 is connected to the second electrical terminal 12 via the printed circuit board 2. Separately therefrom, the first switching contact 4 of the second thyristor 22 is connected to the first electrical terminal 11 via the printed circuit board 2. The first actuator contact 7 of the first actuator 71 bears on the second switching contact 5 of the first thyristor 21 and the first actuator contact 7 of the second actuator 71 bears on the second switching contact 5 of the second thyristor 22. Depending on the driving of the actuators 71, 72, the second actuator contact 8 of the first actuator 71 makes contact with the first electrical terminal 11 and the second actuator contact 8 of the second actuator 72 makes contact with the second electrical terminal 11, or the two actuator contacts 8 are electrically isolated from the respective electrical terminal 11, 12 with the formation of an isolating distance TS.

The middle part of FIG. 8 illustrates a control unit 3, which is connected to the two control contacts 6 of the thyristors 21, 22, on the one hand, and to the two actuators 71, 72 via the driving lines 38, on the other hand. Like the two electrical terminals 11, 12 as well, the control unit 3 is mechanically connected to the printed circuit board 2 via nonconductive holding elements or props 35. The reference symbol 19 designates an electrically insulating potting compound. The latter can be applied, in particular potted onto the printed circuit board 2 after the mounting of the devices according to the invention. The potting compound 19 forms an insulation layer for reducing the air clearances and creepage paths on the printed circuit board 2.

The device 1 described above can also have two contact-making and isolating modules for simplified mounting and contact-making.

The device 1 shown can also be part of a further electronic switching device (not illustrated any further). A switching device of this type has a control terminal 13, which is connected to the control unit 3 for switching on or off the thyristors 21 and 22 and the actuators 71, 72.

It additionally has a housing, on the outer side of which the electrical terminals 11, 12 and the control terminal 13 are arranged and which has the device 1 and the control unit 13. In particular, the control unit 13 drives the actuators 71, 72 in a manner dependent on a switch-on or switch-off command of the thyristors 21, 22. The temporal profile of the driving is illustrated in the two following timing diagrams.

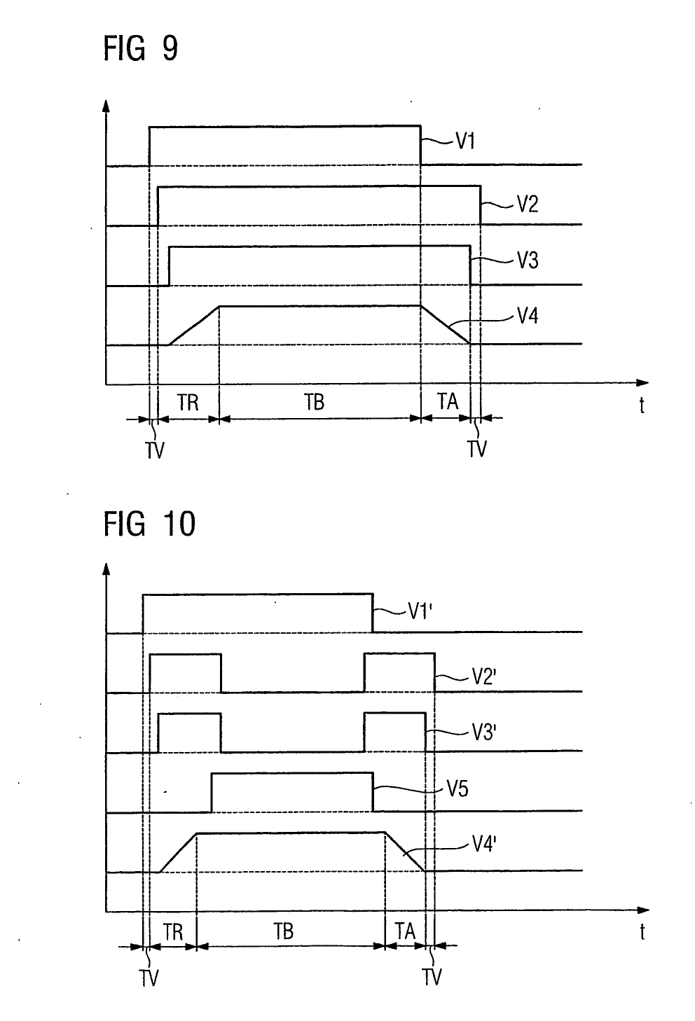

FIG. 9 shows a first timing diagram.

The reference symbol V1 designates the temporal profile of a switch-on/switch-off command for the device 1 according to an embodiment of the invention or for the electronic switching device according to an embodiment of the invention. The switching device is a soft starter in the present example.

With the presence of the switch-on command, after a system-governed delay time TV has elapsed, the electrically isolating distance between the actuator and the semiconductor switch is closed. This is shown by the profile V2. In order to enable the closing advantageously without power, the thyristors are only driven after a short time after the closing of the electrically isolating distance (see profile V3). The thyristors are driven in such a way that the load is softly connected to the input voltage in a ramped manner within a ramp start-up time TR. This is shown by the profile V4. After a rated operation time TB, the soft starter is turned off. Upon reception of the corresponding switch-off command, the thyristor is driven in such a way that the load is isolated from the input voltage in a ramped manner and hence softly. After the thyristors have turned off completely, the actuators are driven for establishing the electrically isolating distance.

FIG. 10 shows a second timing diagram.

It differs from the timing diagram in accordance with FIG. 9 in that an additional bypass switch is driven. It bypasses the electrical terminals of the switching device within the rated operation time in order to avoid unnecessary through-conduction losses at the actuator and in particular at the thyristors (see profile V5). As shown by FIG. 10, when the end of the start-up ramp is reached, the thyristors and then the actuators are switched off after the bypass switch has bypassed the input- and output-side electrical terminals (see profiles V1′-V4′). In a corresponding manner, when a switch-off command is present, first the thyristors and actuators are switched on. This is effected virtually without current since the main current is still passed to the load via the bypass contact. Afterward, the bypass switch is switched off. The current then flowing through the thyristors is driven towards zero in a ramped manner. When the currentless off state of the thyristors is reached, the actuators are driven for establishing the electrically isolating distance.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A device for electrically isolating a first electrical terminal from a semiconductor switch embodied in plate or disk-shaped fashion, the semiconductor switch including a first switching contact on an underside of the semiconductor switch, a second switching contact on a top side of the semiconductor switch and a control contact, the first switching contact of the semiconductor switch being connected to a second electrical terminal, and the second switching contact being electrically isolateable from the first electrical terminal by way of a drivable actuator with the formation of an isolating distance,
the device comprising:
a circuit carrier, on which at least the semiconductor switch and the second electrical terminal are arranged,
the first switching contact of the semiconductor switch being connected on an underside to the circuit carrier and furthermore via the circuit carrier to the second electrical terminal,
the actuator being variable in terms of its length and including two actuator contacts, spaced apart by the length of the actuator and conductively interconnected, wherein the first actuator contact bears on the top side of the second switching contact, and wherein the second actuator contact, depending on the driving of the actuator, either makes contact with the first electrical terminal or is electrically isolated from the first electrical terminal with the formation of the isolating distance.

2. The device as claimed in claim 1, wherein the second switching contact and the control contact are arranged on the top side of the semiconductor switch, and wherein the first switching contact is arranged on the underside of the semiconductor switch, said underside being parallel to the top side.

3. The device as claimed in claim 1, wherein the circuit carrier includes a printed circuit board contact area on which the first switching contact of the semiconductor switch bears.

4. The device as claimed in claim 3, wherein the first switching contact is electrically connected to the printed circuit board contact area via a soldering connection.

5. The device as claimed in claim 1, wherein the actuator includes a cross section substantially co-ordinated with the cross section of the semiconductor switch.

6. The device as claimed in claim 1, wherein the actuator includes a through opening through which contact can be made with the control contact of the semiconductor switch.

7. The device as claimed in claim 1, wherein the first electrical terminal includes a terminal contact lying opposite the second actuator contact.

8. The device as claimed in claim 1, wherein the contacts are embodied in flat fashion.

9. The device as claimed in claim 1, wherein the device has a control unit, which drives the actuator for setting the actuator length.

10. An electronic switching device, comprising:
a device as claimed in claim 1;
the first and second electrical terminal;
a control terminal, connected to the control unit for switching on or off the semiconductor switch and the actuator; and
a housing, on the outer side of which the electrical terminals and the control terminal are arranged, which houses the device and the control unit.

11. The electronic switching device as claimed in claim 10, wherein the actuator and the semiconductor switch are drivable in a manner dependent on a switch-on or switch-off command by way of the control unit.

12. The device as claimed in claim 1, wherein the device has two thyristors connected back-to-back as semiconductor switches, the first and second electrical terminal and also a first and second actuator, wherein
the first switching contact of the first thyristor is connected to the second electrical terminal via the circuit carrier, wherein
separately therefrom, the first switching contact of the second thyristor is connected to the first electrical terminal via the circuit carrier, wherein
the first actuator contact of the first actuator bears on the second switching contact of the first thyristor and the first actuator contacts of the second actuator bears on the second switching contact of the second thyristor, and wherein
depending on the driving of the actuators, the second actuator contact of the first actuator makes contact with the first electrical terminal and the second actuator contact of the second actuator makes contact with the second electrical terminal, or wherein the two actuator contacts are electrically isolated from the respective electrical terminal with the formation of an isolating distance.

13. An electronic switching device comprising:
a device as claimed in claim 12:
the first and second electrical terminal;
a control terminal, connected to the control unit for switching on or off the thyristors and the actuators; and
a housing, on the outer side of which the electrical terminals and the control terminal are arranged and which includes the device and the control unit.

14. The electronic switching device as claimed in claim 13, wherein the control unit drives the actuators in a manner dependent on a switch-on or switch-off command of the thyristors.

15. A contact-making and isolating module for mounting on a circuit carrier, comprising:
a module housing;
an actuator accommodated in the module housing;
an electrical terminal;
a control terminal; and
a control contact terminal, the actuator being driveable such that it can be set in terms of its length and including two actuator contacts, spaced apart by the length of the actuator and conductively interconnected, a first actuator contact of the two actuator contacts being embodied for making contact with a second switching contact, arranged on the circuit carrier on the top side of a semiconductor switch a second actuator contact of the two actuator contacts lying opposite a terminal contact arranged on an inner side of the module housing, the terminal contact being connected to the electrical terminal arranged on the outer side of the module housing, the actuator including a through opening embodied in such a way that a control contact arranged on the top side of the semiconductor element is contact connectable to the control contact terminal through the through opening, wherein, depending on the driving of the actuator, the second actuator contact either makes contact with the terminal contact or is electrically isolated from the latter with the formation of an isolating distance.

16. The contact-making and isolating module as claimed in claim 15, wherein the actuator includes a cross section substantially co-ordinated with the cross section of the semiconductor switch with which contact is to be made.

17. The device as claimed in claim 2, wherein the circuit carrier includes a printed circuit board contact area on which the first switching contact of the semiconductor switch bears.

18. The device as claimed in claim 17, wherein the first switching contact is electrically connected to the printed circuit board contact area via a soldering connection.

19. The device as claimed in claim 8, wherein the contacts are embodied in plane fashion.
